(19) United States
(12) Patent Application Publication
(10) Pub. No.: US 2006/0032382 A1
(43) Pub. Date: Feb. 16, 2006

(54) Integrated compact food process line and process

(76) Inventor: Robert G. Nothum JR., Willard, MO (US)

Correspondence Address: Jonathan A. Bay;Attorney at Law, Suite 314, 333 Park Central East, Springfield, MO, 65806, US

(21) Appl. No.: 11/063,339

(22) Filed: Feb. 22, 2005

Related U.S. Application Data
(63) Continuation of application No. 10/961,476, filed on Oct. 8, 2004, now abandoned.
Application No. 10/961,476 is a continuation of application No. 10/837,503, filed on Apr. 30, 2004, now abandoned.
Application No. 10/837,503 is a continuation of application No. 10/680,558, filed on Oct. 6, 2003, now abandoned.
Application No. 10/680,558 is a continuation of application No. 10/457,032, filed on Jun. 6, 2003, now abandoned.
(60) Provisional application No. 60/386,822, filed on Jun. 7, 2002.

(51) Int. Cl. G07F 9/10

(52) U.S. Cl. 99/357

(57) ABSTRACT

An integrated food process system has a several cells, each having a track forming a horizontal circuit or pathway for a series of product-carrying trays to travel in laps around. The cells afford stacking together in vertically-stacked combinations, multi-variously as desired, to form a tower. The enclosed centers of the cells cooperatively define a hollow core for the tower, which provides space for a drive system that motivates the trays in laps around the tracks, after which the trays are tipped to dump their contents into a corresponding tray in a lower level. There are an assortment of delivery systems for associating with one or more of the cells in order to allow a variety of tower constructions, any one of which can process an infeed of food product through a sequence of operations including combinations of any of cooking, pre-dusting, batter application, breading, frying, freezing, and/or packaging.

### CROSS-REFERENCE TO RELATED APPLICATION(S)

This application is a continuation of U.S. patent application Ser. No. 10/961,476, filed Oct. 8, 2004, which is a continuation of U.S. patent application Ser. No. 10/837,503, filed Apr. 30, 2004, which is a continuation of U.S. patent application Ser. No. 10/680,558, filed Oct. 6, 2003, which is a continuation of U.S. patent application Ser. No. 10/457,032, filed Jun. 6, 2003, which claims the benefit of U.S. Provisional Application No. 60/386,822, filed Jun. 7, 2002, which was originally presented as U.S. Provisional Application No. 60/297,402, filed Jun. 11, 2001. All the foregoing patent applications are fully incorporated herein by reference.

### BACKGROUND AND SUMMARY OF THE INVENTION

The invention generally relates to large scale food process lines of the type having a series of machines or stations arranged together and performing distinct processes on articles of food product for ultimately producing packaged and frozen food product. The frozen and packaged food product affords distribution to restaurant and/or consumer grocery stores and the like. For example and without limitation, in the case of frozen chicken strips for the fast food or consumer grocery stores, such a food process line might comprise the following stations in series:—a) pre-dust, b) batter, c) bread, d) batter (again), e) fry and freeze and package and so on.

Given the foregoing, the invention more particularly relates to an integrated food line which accomplishes much of the same work as accomplished by the known large scale food process lines except by an integrated apparatus which is also scaled to a relatively more compact size.

It is an object of the invention to eliminate the typical belting nowadays popular in conventional process lines.

It is an alternate object of the invention to reduce the amount of floor space required for installation of such a food process line.

It is an additional object of the invention to treat or process food pieces individually, in contrast to collectively in mass, for various if not all the sub-process or stages of the whole food process task.

It is another object of the invention to automate the cleaning thereof, as thoroughly or more thoroughly than nowadays achieved conventionally manually.

It is a further object of the invention to bring new physical processes, data collection and control to food processing.

A number of additional features and objects will be apparent in connection with the following discussion of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a top plan view of an integrated compact food process line in accordance with the invention, including isolation views a batter station and a pre-dust station;

FIG. 2 is a perspective view of the integrated compact food process line in accordance with the invention, which shows multiple levels or elevations of operability including showing upper level(s) having batter application, middle level(s) having frying operability including a drip return, and bottom level(s) operating as a holding area or also allowing cool down;

FIG. 3 shows a configuration or alternatively re-configuration of the integrated compact food process line in accordance with FIG. 2 and showing further aspects of the invention as its operability to handle dusting operations by one or more dusting stations with different type of seasonings within, wherein each duster and also the batter portion have a gear-driven applicator rotatable by a rack portion of individual food trays as each food tray as rotated around the center drum, which as better shown by FIG. 1, each food tray is motivated around the outer perimeter of the center drum by the four-spoked center shaft;

FIG. 4 is a perspective view of the four-spoked center shaft referenced above as shown in isolation;

FIG. 5 is a top plan view comparable to FIG. 1 except illustrating the worm-gear drive connection for the four-spoked center shaft;

FIG. 6 is an elevational view, partly in section, taken along line VI-VI in FIG. 5 and showing the relationship of the center drum, food tray and location of the center shaft's involved spoke;

FIG. 7 is a sectional view comparable to FIG. 6 except taken along line VII-VII in FIG. 5 and showing the relationship of the leading edge of the food tray and the center drum;

FIG. 8 is a perspective view showing multiple interchangeable trays for a given carrier or rack;

FIG. 9 is a sectional view taken along line IV-IV in FIG. 3 and illustrating the relation of a food tray with the rear engagement means for rotation of the duster means;

FIG. 10 is a sectional view taken through line X-X in FIG. 9 and showing further aspects of the relation between the food tray and the dusting means;

FIG. 11 is a side elevational view of the batter dispensing process relative to the tracking of a food tray, wherein batter is deposited on the lower tray prior to the food tray's contents being covered by batter on the top half, and in turn batter is deposited on all sides of the food matter;

FIG. 12 is a top plan view of a single layer or horizon of the integrated food process line in accordance with the invention;

FIG. 13 is an exploded side elevation view showing a cell in FIG. 12 above a corresponding base structure therefor; and

FIG. 14 is sectional view, partly broken away, taken through the outer track or ring of the cell in FIG. 12 or 13 and showing the magnet coupling between a drive system and one food-product carrying tray in the track.

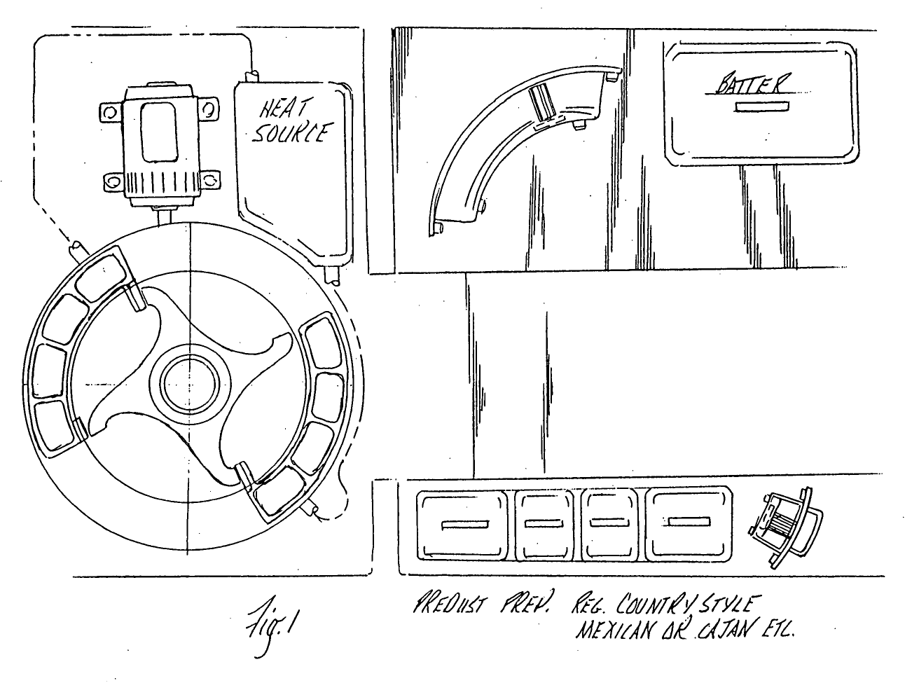

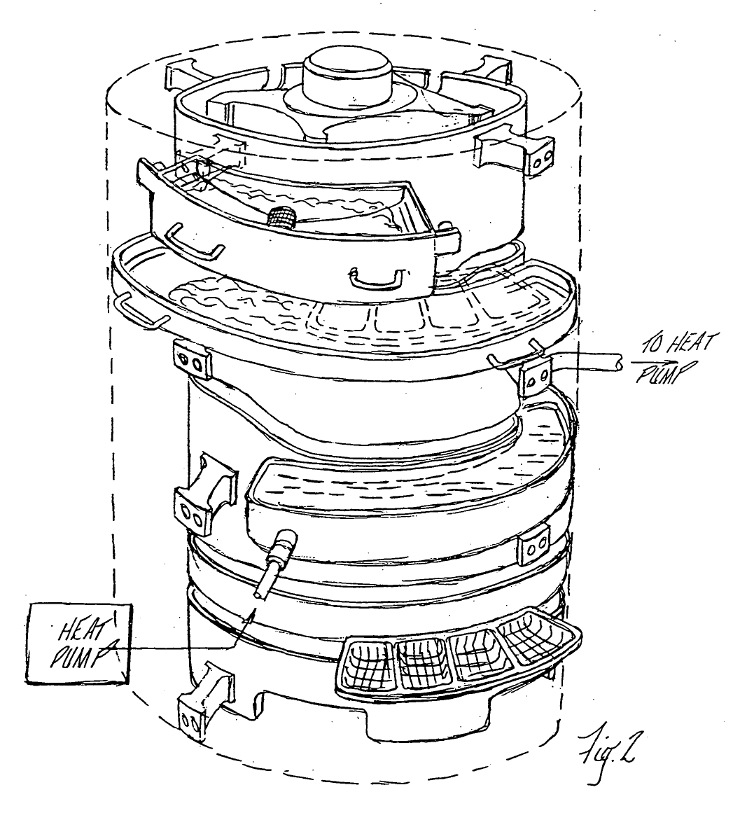

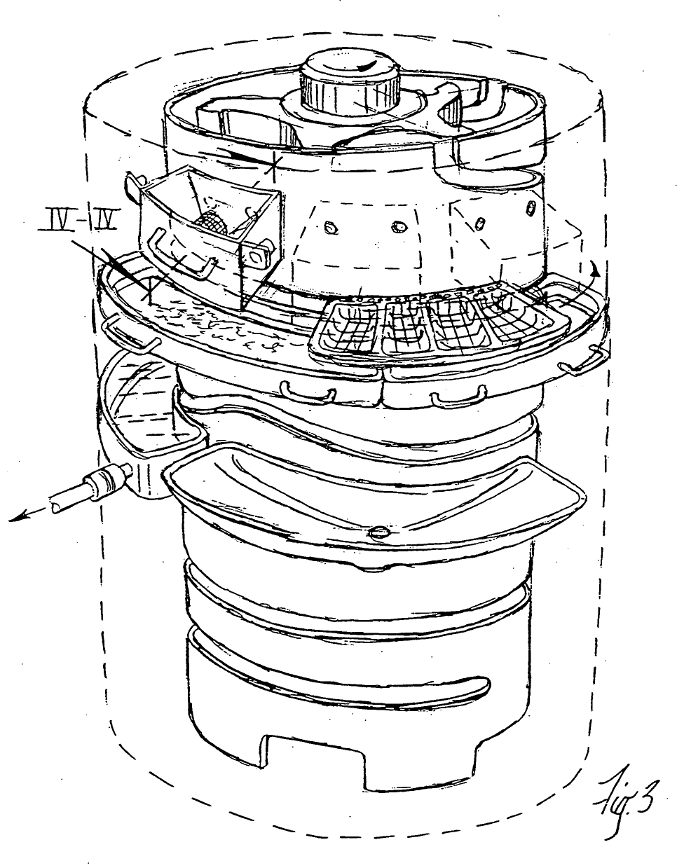

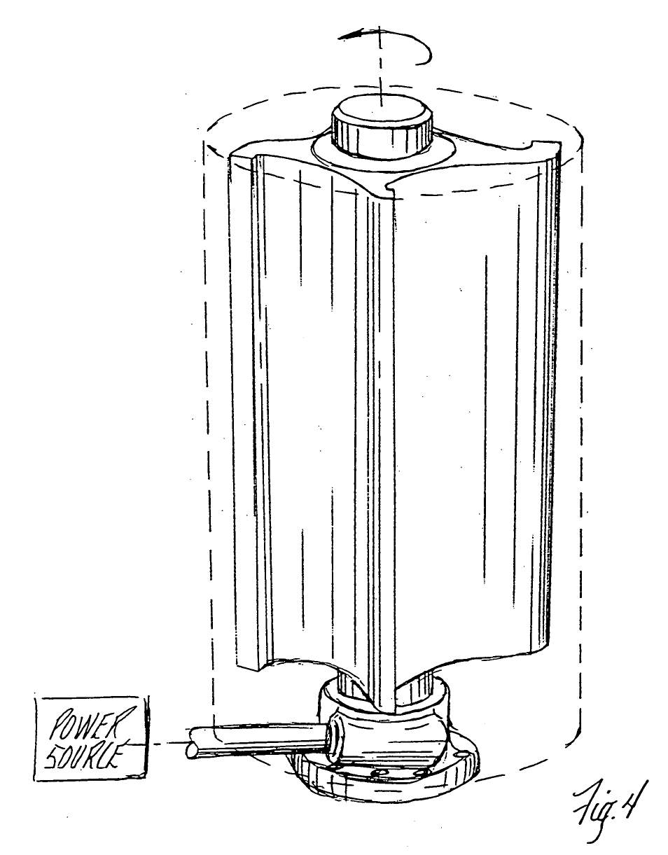

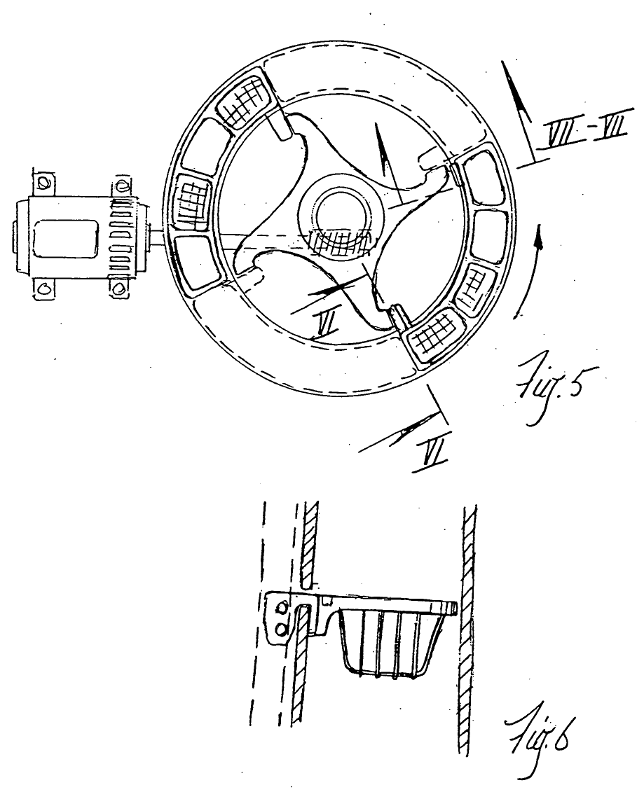

### DETAILED DESCRIPTION OF THE PREFERRED EMBODIMENTS

The drawings depict one preferred embodiment of an integrated compact food process line and process in accordance with the invention.

A group or different, individual processes are performed by cells or the like that can be stacked or configured in such a way as to work in a variety of combinations. For example, various cells might include without limitation a cell for 1) product forming, 2) cooking, 3) pre-dusting, 4) batter application, 5) breading, 6) frying, 7) freezing, and/or 8) packaging. Each cell (or cells) performing any of the above-enumerated processes can be operated independently of any of the other enumerated processes, or in any combination or, within limits, sequence of the enumerated processes, in order to achieve an overall food product job as desired.

The concepts described below will basically work for any or all of the above-enumerated processes in terms of containing, conveying and transferring among processes such things as individual pieces of food product or groups of individual food products as they are processed and moved to the next process.

Preferably the various processes are completed in levels or horizontal zones so that combinations thereof can be stacked vertically. FIG. 12, among others, shows a representative cell for undertaking a given process. FIG. 13 shows a given process cell and its optional base, if any. The cell contains individual product holders that travel in a circuit from an origin to a termination. The geometry might be without limitation circular circuits as shown. If so, preferably the termination is angularly spaced from the origin by 350° to 359° or so. The hollow center of the cell's circuit affords space for placing drive, control and delivery systems. Alternatively or in addition, the cell may work best if coupled with a base, in which event the base affords further opportunity for locating drive, control, and/or delivery systems. Wherein, by delivery systems, what is meant includes without limitation thermal fluid (eg., hot oil) for cooking and/or refrigerant for cooling/freezing and so on.

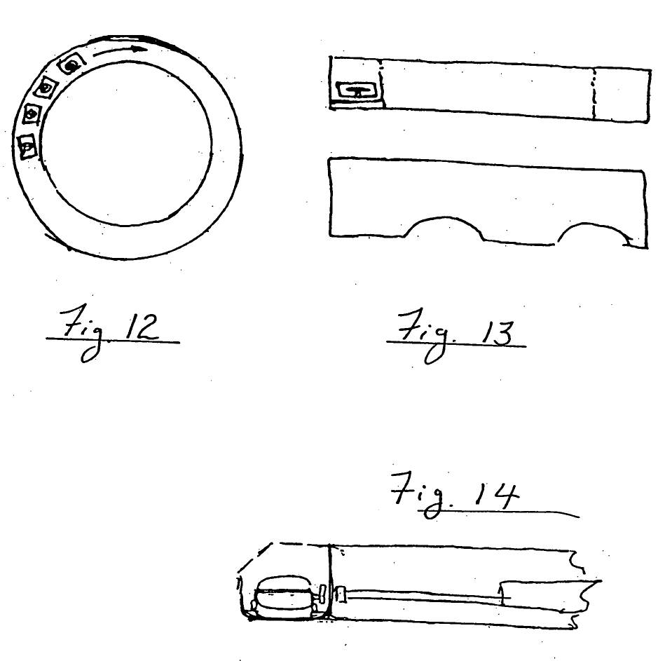

Hence each cell preferably defines a circuit in the form of a track, as shown by FIG. 14 in section view. The track will impose an orderly path on the holders or trays that lap around the track. The holders or trays do the actual carrying of food product including if desired individual pieces of food product, such as from original introduction of raw food product and on through forming, cooking, pre-dusting, batter, breading, frying, freezing and packaging and the like.

Each tray is motivated along the track by either riding on rollers, or non-stick dry surfaces, or lubricated surfaces, or else propped up slightly by a bed of air jets or field of magnetic levitation. The tray can be coupled to the drive source by a magnetic couple as shown in FIG. 14 on opposites sides of the track's inner sidewall, by an attracting magnet on the end of a driven spoke, wherein the attracting magnet moves in revolutions about the inside of the track's inner sidewall. This is done in a way that the spoke can be made to make the trays rotate, or bounce up and down, all the while as being motivated along the path imposed by the track. At the termination (or 350° to 359° point), the tray is preferably made to rotate in order to dump its content(s) onto a lower level for a different process in the procession.

Some cells might have bases which are common to the process. The cells (eg., process modules) can be stacked on top of each other in such a way to be integrated one with another, or alternatively one cell-base unit with another cell or cell-base unit.

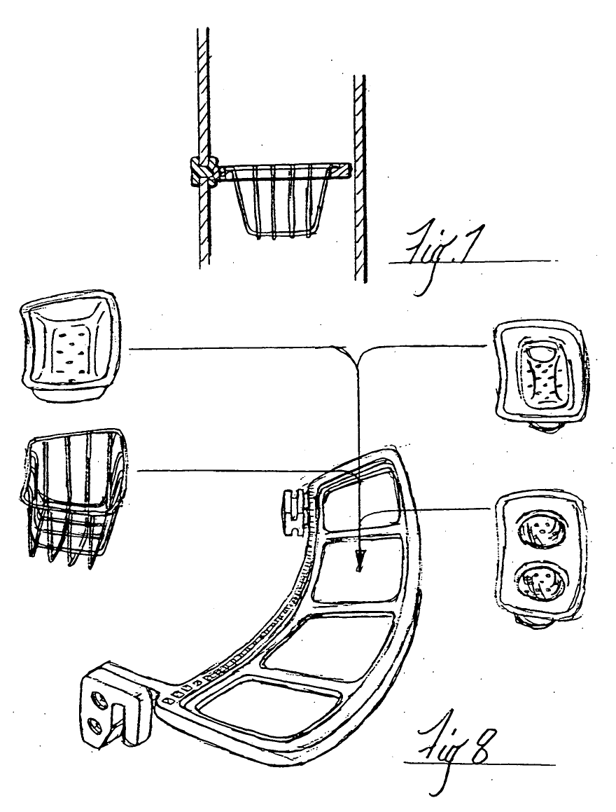

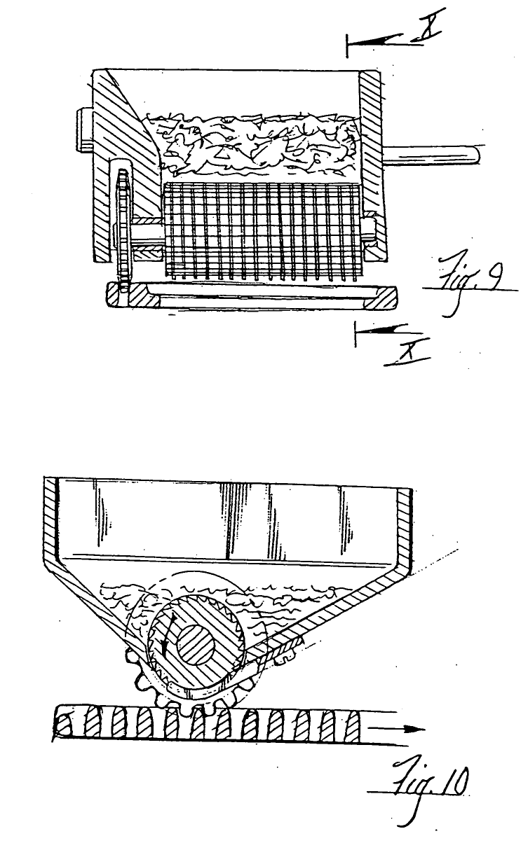

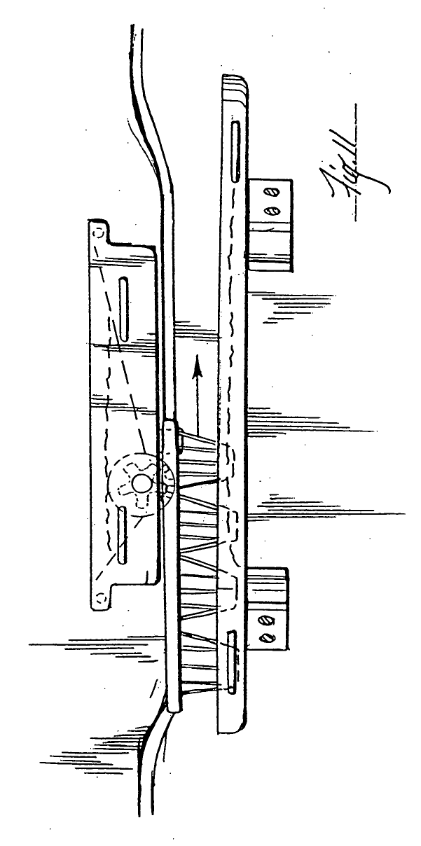

FIG. 8 shows that the invention includes an interchangeable assortment of trays for carrying product. In addition, it is an aspect of the invention to include specially-designed trays with a cavity properly shaped for molding a given product to form. Such a tray receives a pre-portioned amount of raw food material such as meat or a mix. An overhead structure such as lid, plunger or roller would press the received portion to conform to the shape of the tray as the tray moves around the track path. At the end of the track path, the source of pressure would be lifted and/or removed. After that, the formed portion would be free to be dumped, dropped or, more delicately, lowered to a waiting tray in the lower level for a successive process.

To turn to matters of optimizing design of the sequence of processes, it is preferred in cases of some food products to fully cook them prior to coating and further downline cooking processes such as frying and the like. Generally, cooking makes the product fit for human consumption, whereas frying downline from a prior cooking process serves more, not to cook the food product but, to set the coating and batter added after the prior cooking process. Put differently, whereas the early cooking process renders the raw food product fit for human consumption, the later frying process crispens the coatings, breading or batter and the like more significantly for flavor's sake (in contrast to cooking the raw batter too). Given that background on an early cooking process, such an early cooking process can be combined with the product forming process described above. That is, during the same time as the forming procedure, the tray can be adapted with a thermal jacket that will accept an injection of a thermal fluid for thermal delivery. Alternatively, the pressure plate or roller (for forming the product) can be outfitted for thermal delivery. However thermal delivery is achieved, it is an aspect of the invention to form and cook simultaneously, or at least in the same cell/level of the integrated food process line in accordance with the invention. Indeed, the cooking process could be carried out in a later (succeeding) process or cell/level but also in a very similar manner as just described.

Nowadays it is conventional for a straight-line food process line to be built with separate machines linked together to perform a chain of events. A typical line that would be as simple as pre-dust, batter, bread and fry might measure thirty to fifty feet (9 to 15 m) or more in length. One advantage of the invention, among numerous others, is that it renders such length needless because the system is constructed on a circuit principle, with the separate circuits coupled to each other by stacking, eg., layer cake style. For example, a single circuit, if circular, has a ten foot (3 m) diameter, this corresponds to thirty feet (9 m) of straight-line length. Consequently, the integrated food process line in accordance with the invention affords a more compact footprint, in terms of finding floor space for it.

The inventor hereof is the sole or joint inventor of the next-listed U.S. Patents and/or U.S. patent applications, the disclosures of which are incorporated herein in full by this references thereto:
U.S. Pat. No. 6,158,332—Convertible Drum-type Coating Apparatus;
U.S. Pat. No. 6,305,274—Fryer for Food Process Lines;
U.S. Pat. No. 6,512,810 (B2)—Convertible Combination Batter Mixer and Applicator Machine;
U.S. patent application Ser. No. 10/339,175—Spiral Freezer, Refrigeration Delivery, Enclosure and Drive; and,
U.S. patent application Ser. No. 10/339,176—Spiral Oven, Heat Delivery, Enclosure and Drive.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. An integrated food process line comprising:
a multiplicity of food-product carrying trays for holding and carrying food product;
a plurality of operative cells, each having a track forming a horizontal circuit for defining a pathway for a series of said trays to travel in laps around such pathway, said cells defining enclosed centers;
said cells including mounting structure to stack together in vertically-stacked combinations, multi-variously as desired, to form a tower, wherein said enclosed centers cooperatively define a hollow core for said tower;
a drive system for said trays disposed externally of said cells for motivating said trays in laps around the respective tracks in which a respective series is situated in and for causing transfer of food product from a given tray in one level to a corresponding tray in another level;
an assortment of delivery systems for associating with one or more cells, including any of raw food-product delivery from a supply thereof, dust-material delivery from a supply thereof, breading material delivery from a supply thereof, batter delivery from a supply thereof, thermal delivery from a source or supply thereof, refrigerant delivery from a source or supply thereof, and/or packaging-material delivery from a supply thereof;
a corresponding assortment of cell/delivery-system coupling systems which afford a variety of tower constructions any one of which can process an infeed of food product through a sequence of operations including combinations of any of cooking, pre-dusting, batter application, breading, frying, freezing, and/or packaging.

2. The integrated food process line of claim 1 further comprising a cell for product forming, which cell includes a structure for applying pressure on food product contained in a tray to cause such food product to mold in the shape of the tray and contact surface(s) of the pressure structure.

3. The integrated food process line of claim 2 wherein said product-forming cell is coupled with a thermal delivery system to both form and cook food product during the lap of the trays in the product-forming cell.

4. The integrated food process line of claim 1 wherein said drive system includes magnet coupling between said drive system and the trays.

5. The integrated food process line of claim 1 wherein said drive system includes coupling between said drive systems and trays to cause said trays to rotate at a given zone along the track of the respective cell in order that the food product is dumped into a receiving tray in a lower cell.

6. An integrated food process line comprising:
a multiplicity of food-product carrying trays for holding and carrying food product;
a plurality of operative cells, each having a track forming a horizontal circuit for defining a pathway for a series of said trays to travel in laps around such pathway, said cells defining enclosed centers;
said cells including mounting structure to stack together in vertically-stacked combinations, multi-variously as desired, to form a tower, wherein said enclosed centers cooperatively define a hollow core for said tower;
a drive system for said trays disposed externally of said cells for motivating said trays in laps around the respective tracks in which a respective series is situated in and for causing transfer of food product from a given tray in one level to a corresponding tray in another level;
an assortment of delivery systems for associating with one or more cells, including any of raw food-product delivery from a supply thereof, dust-material delivery from a supply thereof, breading material delivery from a supply thereof, batter delivery from a supply thereof, thermal delivery from a source or supply thereof, and/or refrigerant delivery from a source or supply thereof;
a corresponding assortment of cell/delivery-system coupling systems which afford a variety of tower constructions any one of which can process an infeed of food product through a sequence of operations including combinations of any of cooking, pre-dusting, batter application, breading, frying, freezing, and/or packaging.

7. The integrated food process line of claim 6 further comprising a cell for product forming, which cell includes a structure for applying pressure on food product contained in a tray to cause such food product to mold in the shape of the tray and contact surface(s) of the pressure structure.

8. The integrated food process line of claim 7 wherein said product-forming cell is coupled with a thermal delivery system to both form and cook food product during the lap of the trays in the product-forming cell.

9. The integrated food process line of claim 6 wherein said drive system includes magnet coupling between said drive system and the trays.

10. The integrated food process line of claim 6 wherein said drive system includes coupling between said drive systems and trays to cause said trays to rotate at a given zone along the track of the respective cell in order that the food product is dumped into a receiving tray in a lower cell.
